(19) United States
(12) Patent Application Publication
(10) Pub. No.: US 2008/0265825 A1
(43) Pub. Date: Oct. 30, 2008

(54) High-Current High-Resolution Driving Circuit

(76) Inventor: Alex Yu-Kwen Su, Sinjuang City (TW)

Correspondence Address: LAW OFFICES OF LAI AND ASSOCIATES, P.C., 5800 RANCHESTER STE 200, HOUSTON, TX, 77036, US

(21) Appl. No.: 11/762,718

(22) Filed: Jun. 13, 2007

(30) Foreign Application Priority Data
Apr. 25, 2007 (TW) 096114666

(51) Int. Cl. G05B 19/40; G05B 19/29; H02P 7/00; H02P 7/29; H02P 8/00

(52) U.S. Cl. 318/685; 318/135; 318/600; 318/696; 388/811

(57) ABSTRACT

The present invention discloses a high-current high-resolution driving circuit comprising a controller, a digital-to-analog converter and a voltage-to-current converter. The controller is provided for receiving a control signal for operating a load and outputting a digital signal corresponding to the control signal. The digital-to-analog converter is provided for generating an analog voltage signal corresponding to the digital signal. The voltage-to-current converter is provided for generating a current signal corresponding to the analog voltage signal and transmitting the current signal to the load in order to drive the load.

### FIELD OF THE INVENTION

The present invention relates to a high-current high-resolution driving circuit, and more particularly to a driving circuit that integrates a digital-to-analog converter.

### BACKGROUND OF THE INVENTION

Referring to FIG. 1 for a schematic view of a conventional high-current driving circuit, the driving circuit includes an operational amplifier (OP) 11 and a voltage-to-current converter 12, and an input terminal of the operational amplifier 11 is provided for receiving a control voltage signal Vc, and another input terminal is connected to an output terminal of the operational amplifier 11 to form a feedback loop. The voltage-to-current converter 12 is connected to an output terminal of the operational amplifier 11 for generating a current signal 121 based on the output voltage of the operational amplifier 11 to drive a load 13 such as a motor, a speaker or an optical disk drive. Since the conventional driving circuit uses an operational amplifier OP to amplify signals and the OP is an analog component, the circuit is interfered by noises easily and the ratio of the output voltage to the control voltage signal cannot be controlled precisely so that the load cannot be driven for precise operations such as the control of rotary speed or movement in high resolution.

In view of the shortcomings of the prior art, the inventor of the present invention based on years of experience in conducting extensive research and experiments, finally developed a high-current high-resolution driving circuit in accordance with the present invention to overcome the shortcomings of the prior art.

### SUMMARY OF THE INVENTION

It is a primary objective of the present invention to provide a high-current high-resolution driving circuit for improving the efficiency of controlling a load.

To achieve the foregoing objective, the present invention provides a high-current high-resolution driving circuit for generating a current signal to drive a load, and the driving circuit comprises a controller, a digital-to-analog converter and a voltage-to-current converter. The controller is provided for receiving a control signal for operating the load and outputting a digital signal corresponding to the control signal. The digital-to-analog converter is provided for generating an analog voltage signal corresponding to the digital signal. The voltage-to-current converter is provided for generating a current signal corresponding to the analog voltage signal and transmitting the current signal to the load.

The present invention further provides a driving circuit applicable for a motor, and the driving circuit comprises a controller, a digital-to-analog converter and a driving unit. The controller is provided for receiving a control signal for operating a motor and outputting a digital signal corresponding to the control signal. The digital-to-analog converter is provided for generating an analog voltage signal corresponding to the digital signal. The driving unit is provided for generating a driving signal corresponding to the analog voltage signal and transmitting the driving signal to the motor.

If the motor is a stepping motor, the driving unit includes a pulse width modulation (PWM) signal generation circuit to generate a PWM signal having the width of a duty cycle (or a pulse width) approximately proportional to the analog voltage signal. If the motor is a linear direct current motor, the driving unit includes a voltage-to-current converter to generate a current signal approximately proportional to the analog voltage signal.

In view of the description above, the high-current high-resolution driving circuit in accordance with the present invention has the following advantages:
(1) The high-current high-resolution driving circuit can generate a high-resolution current signal for driving a load for fine-tune operations.
(2) The high-current high-resolution driving circuit adopts a digital-to-analog conversion circuit for reducing or eliminating the interference of noises.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a schematic view of a conventional high-current driving circuit;

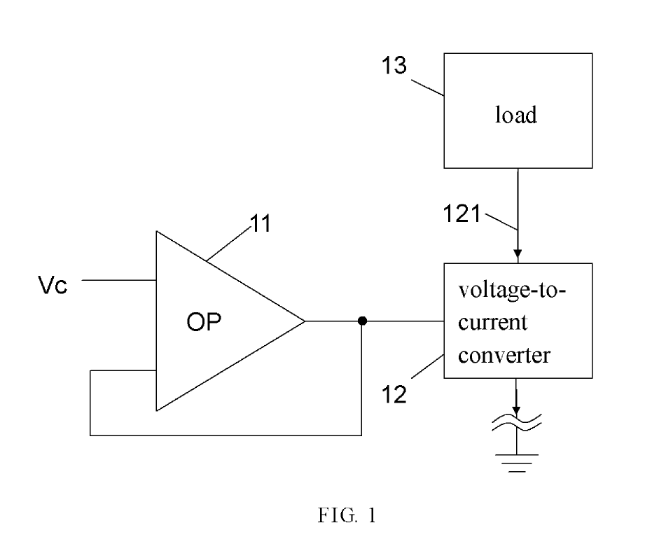

FIG. 2 is a block diagram of a high-current high-resolution driving circuit in accordance with the present invention;

FIG. 3 is a schematic view of a high-current high-resolution driving circuit in accordance with a preferred embodiment of the present invention; and

FIG. 4 is a schematic view of a stepping motor applicable for a high-current high-resolution driving circuit in accordance with a preferred embodiment of the present invention.

### DETAILED DESCRIPTION OF THE PREFERRED EMBODIMENTS

In the related figures of a preferred embodiment of the present invention, the same referring numerals are used for the same elements in accordance with the present invention.

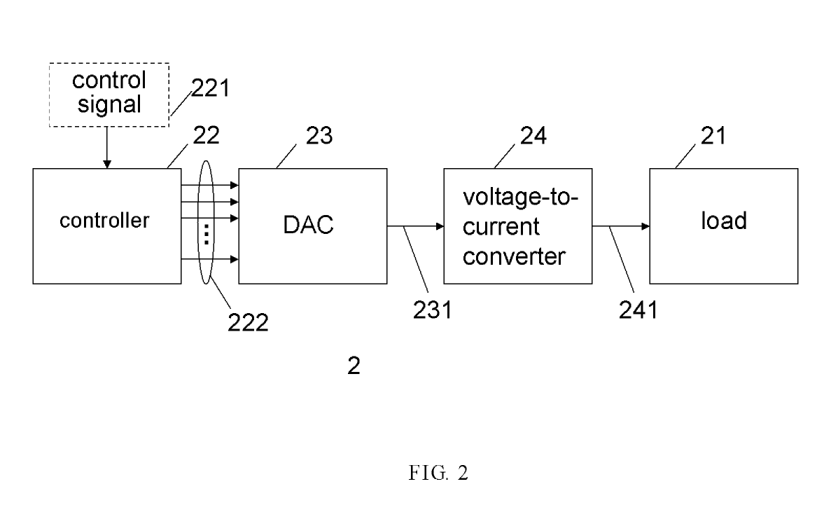

Referring to FIG. 2 for a block diagram of a high-current high-resolution driving circuit in accordance with the present invention, the driving circuit 2 is provided for generating a current signal to drive a load 21 such as a speaker, an optical disk drive, a stepping motor or a linear direct current motor (LDM) such as a voice-coil motor (VCM). The driving circuit 2 comprises a controller 22, a digital-to-analog converter 23 and a voltage-to-current converter 24.

The controller 22 receives a control signal 221 for operating a load 21 and outputs a digital signal 222 corresponding to the control signal 221, and the controller 22 can be a microprocessor or a microcontroller. The control signal 221 is a command for operating the load 21. If the load 21 is a voice-coil motor, then the controller 22 can receive a command signal to move the voice-coil motor to a specific position. The digital signal 222 includes a plurality of binary signals, and the binary signals are represented by numeric values. Further, the controller 22 can install different interfaces such as Inter-integrated Circuit (I²C) interface, Serial Peripheral Interface (SPI) or Universal Asynchronous Receiver-Transmitter (UART) interface for receiving commands.

The digital-to-analog converter (DAC) 23 is provided for receiving the digital signal 222 to generate an analog voltage signal 231 corresponding to the digital signal 222, wherein the voltage of the analog voltage signal 231 is related to the voltage of the digital signal 222. For instance, if the digital-to-analog converter 23 receives four binary signals, and the maximum output voltage is 3.2V, and the minimum output voltage is 0V, then the digital-to-analog converter 23 can output 16 different levels of voltage values (0V, 0.2V, 0.4V, 0.6V, ˜2.8V, 3.0V and 3.2V), and the difference of adjacent voltage values is approximately equal to 0.2V. The digital-to-analog converter 23 is a digital-to-analog conversion circuit such as a capacitive digital-to-analog conversion circuit, a resistive digital-to-analog conversion circuit or a current steering digital-to-analog conversion circuit. The driving circuit, if needed, further comprises a compensation circuit connected to the digital-to-analog conversion circuit for enhancing the matching of components (such as a capacitor, a resistor or a transistor) of the digital-to-analog conversion circuit as well as enhancing the precision of the digital-to-analog conversion circuit. If the digital-to-analog converter 23 is a capacitive digital-to-analog conversion circuit then the compensation circuit can enhance the precision of proportion of different capacitors.

The voltage-to-current converter 24 is provided for receiving the analog voltage signal 231 and generating a current signal 241 corresponding to the analog voltage signal 231 and transmitting the current signal 241 to the load 21. The current signal 241 is a large current greater than 1 mA, and the current signal 241 and the digital signal 222 have a relation of high linearity. In other words, the current signal 241 is approximately proportional to the numeric value of the digital signal 222. The voltage-to-current converter 24 is composed of at least one transistor such as a power transistor applicable for a large current output.

One of the main characteristics of the driving circuit in accordance with the present invention resides in that the driving circuit can output a high-resolution current signal to the load 21 to achieve the effect of controlling the load precisely. For instance, a voice-coil motor is a linear direct current motor, and its pushing force is directly proportional to the current passing through the windings of a magnet, so that if a 10-bit DAC driving circuit is used for driving the voice-coil motor, then the driving circuit will generate 1024 different levels of current signals to drive the voice-coil motor to produce 1024 different kinds of pushing forces. If such voice-coil motor is used for pushing the focusing lens of a camera, then the focusing lens can be tuned to achieve a better focusing effect. Compared with an analog amplifier, the digital-to-analog converter 23 will not be interfered by noises so easily, and thus the output of the analog signal has a higher precision.

If the load is a stepping motor, then the driving circuit 2 can include a pulse width modulation (PWM) signal generation circuit for generating a PWM signal corresponding to the current signal and transmitting the PWM signal to the stepping motor. In other words, the PWM signal having the width of a duty cycle (or a pulse width) is approximately proportional to the intensity of the current signal.

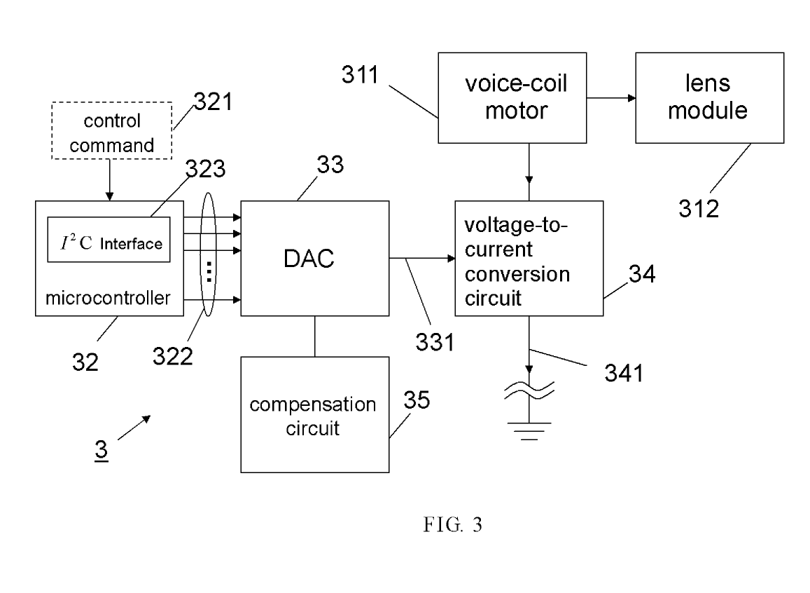

Referring to FIG. 3 for a schematic view of a high-current high-resolution driving circuit in accordance with a preferred embodiment of the present invention, the driving circuit 3 is provided for driving a voice-coil motor 311 in a camera to push a lens module 312 for focusing. The driving circuit 3 comprises a microcontroller 32, a digital-to-analog conversion circuit 33, a compensation circuit 35 and a voltage-to-current conversion circuit 34. The microcontroller 32 receives an operation command 321 through an I2C interface 323 and outputs a digital signal 322 to a digital-to-analog conversion circuit 33 according to the operation command 321. The digital-to-analog conversion circuit 33 outputs an analog voltage signal 331 to the voltage-to-current conversion circuit 34 based on the binary signals included in the digital signal 322 for generating a current signal 341 approximately proportional to the analog voltage signal 331. The current signal 341 is provided for driving the voice-coil motor 311 to push a lens module 312. The compensation circuit 35 can enhance the matching of components of the digital-to-analog conversion circuit 33 as well as the precision of the analog voltage signal 331.

In this preferred embodiment, if the maximum analog voltage signal outputted by the digital-to-analog conversion circuit 33 is VH and the minimum analog voltage signal is VL, then the voice-coil motor 311 can push the lens module 312 to the farthest position P1 and the nearest position P2. If the digital-to-analog conversion circuit 33 is a 5-bit digital-to-analog conversion circuit, then it can output 32 different analog voltage signals between VH and VL, and thus the voice-coil motor 311 can push the lens module 312 to 32 different positions between the farthest position P1 and the nearest position P2. Similarly, if the digital-to-analog conversion circuit 33 is a 12-bit digital-to-analog conversion circuit, then the lens module 312 can be pushed to 4096 different positions between P1 and P2, so that the lens module 312 can be tuned in a finer manner, and the lens can be focused more precisely.

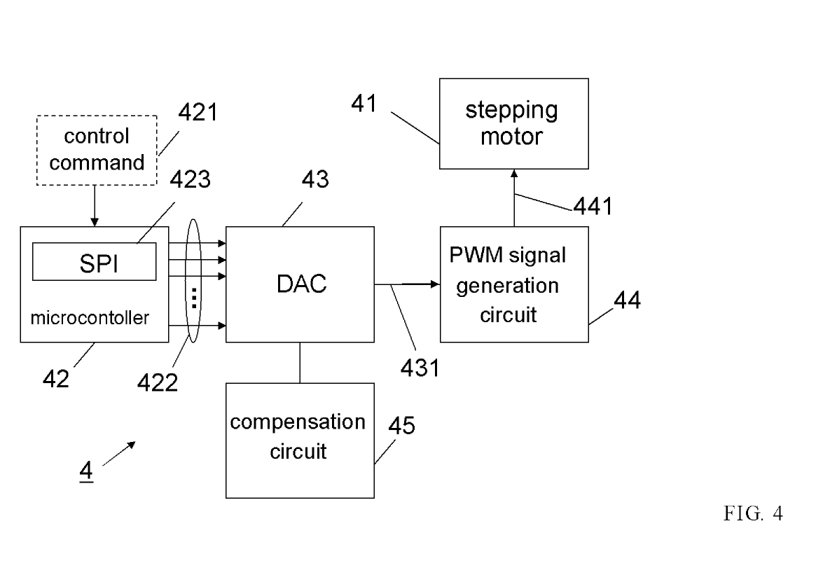

Referring to FIG. 4 for a high-current high-resolution driving circuit applicable for a stepping motor in accordance with a preferred embodiment of the present invention, the driving circuit 4 is provided for driving a stepping motor 41, and the driving circuit 4 comprises a microprocessor 42, a digital-to-analog conversion circuit 43, a compensation circuit 45 and a PWM signal generation circuit 44. The microprocessor 42 receives an operation command 421 through an SPI interface 423 and outputs a digital signal 422 to the digital-to-analog conversion circuit 43 according to the content of the operation command 421. The digital-to-analog conversion circuit 43 outputs an analog voltage signal 431 to the PWM signal generation circuit 44 based on the binary signal included in the outputted digital signal 422 for generating a PWM signal 441 having the width of a duty cycle (or a pulse width) approximately proportional to the analog voltage signal 331, so as to drive the stepping motor 41. Since the rotary speed of the stepping motor 41 is related to the width of the duty cycle of the PWM signal 441, a user can set the rotary speed of the stepping motor 41 precisely by a command for a fine-tune control. The compensation circuit 45 can enhance the matching of components of the digital-to-analog conversion circuit 43 as well as the precision of the analog voltage signal 431.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A high-current high-resolution driving circuit, for generating a current signal to drive a load, comprising:
a controller, for receiving a control signal to operate the load and outputting a digital signal corresponding to the control signal;
a digital-to-analog converter, for generating an analog voltage signal corresponding to the digital signal; and
a voltage-to-current converter, for generating a current signal corresponding to the analog voltage signal and transmitting the current signal to the load.

2. The driving circuit of claim 1, wherein the load is a motor, an optical disk drive or a speaker.

3. The driving circuit of claim 1, wherein the digital signal and the current signal have a relation of high linearity.

4. The driving circuit of claim 1, wherein the current signal is greater than 1 mA.

5. The driving circuit of claim 1, further comprising a pulse width modulation (PWM) signal generation circuit, for generating a PWM signal corresponding to the current signal and transmitting the PWM signal to the load.

6. A high-current high-resolution driving circuit, applicable in a motor, and the driving circuit comprising:
a controller, for receiving a control signal to operate the motor and outputting a digital signal corresponding to the control signal;
a digital-to-analog converter, for generating an analog voltage signal corresponding to the digital signal; and
a driving unit, for generating a driving signal corresponding to the analog voltage signal and transmitting the driving signal to the motor.

7. The high-current high-resolution driving circuit of claim 6, wherein the motor is a stepping motor, and the driving unit includes a PWM signal generation circuit, for generating a PWM signal having the width of a duty cycle approximately proportional to the analog voltage signal.

8. The high-current high-resolution driving circuit of claim 6, wherein the motor is a linear direct current motor, and the driving unit includes a voltage-to-current converter, for generating a current signal approximately proportional to the analog voltage signal.

9. The high-current high-resolution driving circuit of claim 8, wherein the current signal is greater than 1 mA.
